(19) United States
(12) Patent Application Publication
(10) Pub. No.: US 2018/0048020 A1
(43) Pub. Date: Feb. 15, 2018

(54) LITHIUM-ION POLYMER BATTERY AND ELECTRONIC DEVICE

(71) Applicant: Lenovo (Beijing) Co., Ltd., Beijing (CN)

(72) Inventors: Xiaotian ZOU, Beijing (CN); Baoning HUANG, Beijing (CN); Bingcai LUO, Beijing (CN)

(21) Appl. No.: 15/588,241

(22) Filed: May 5, 2017

(30) Foreign Application Priority Data
Aug. 12, 2016 (CN) 201610663650.3
Aug. 12, 2016 (CN) 201610664851.5
Aug. 12, 2016 (CN) 201610665821.6

(51) Int. Cl. H01M 10/0525; H01M 10/0567; H01M 4/38; H01M 4/48; H01M 4/62; H01M 4/36; H01M 10/0569; H01M 2/16

(52) U.S. Cl. CPC H01M 10/0525; H01M 10/0569; H01M 10/0567; H01M 2/1686; H01M 4/483; H01M 4/625; H01M 4/364; H01M 4/386; H01M 2220/30; H01M 2300/004; H01M 2004/028

(57) ABSTRACT

Lithium-ion polymer batteries and electronic devices thereof are provided. A lithium ion polymer battery includes a battery electrolyte. The battery electrolyte includes a solvent and an additive. The solvent includes propyl propionate and at least two selected from the group consisting of ethylene carbonate, diethyl carbonate, and propylene carbonate. The additive includes one or more of ethylene sulfate, fluoroethylene carbonate, hexanedinitrile, ethylene glycol bis(propionitrile) ether, 1,3-propyl sultone, and fluorobenzene.

### CROSS-REFERENCE TO RELATED APPLICATIONS

This application claims priority to Chinese Patent Application Nos. 201610664851.5, 201610663650.3, and 201610665821.6, all filed on Aug. 12, 2016, the entire contents of all of which are incorporated herein by reference.

### TECHNICAL FIELD

The present disclosure relates to the technology of lithium-ion battery and, more particularly, to a lithium-ion polymer battery and an electronic device including a lithium-ion polymer battery.

### BACKGROUND

Conventional lithium batteries use lithium or lithium alloy as a cathode material while lithium-ion batteries use lithium-ion-inserted carbon as the cathode material. Further, in the lithium-ion batteries, the anode material may include LiₓCoO₂, or LiₓNiO₂ and LiₓMnO₄, and the electrolyte may include LiPF₆ or a mixture of ethylene carbonate (EC) and dimethyl carbonate (DMC).

The cathode materials used in the lithium-ion batteries are often nontoxic and widely available. Further, since lithium-ions are inserted into the carbon forming the cathode, negative effect caused by the high activity of lithium-ions may be overcome. Thus, lithium-ion batteries are safer than conventional lithium batteries. Moreover, the anode material LiₓCoO₂ has a relatively high charging-discharging performance and a relatively long lifetime, thus lithium-ion batteries may have a lower cost and a superior comprehensive property. Therefore, lithium-ion batteries have been more and more widely used.

Lithium-ion batteries may be classified into two categories based on the electrolyte used, i.e., lithium-ion liquid batteries and lithium-ion polymer batteries. As compared to lithium-ion liquid batteries, because lithium-ion polymer batteries use solid-state electrolyte instead of liquid electrolyte, they may be made thin and made into any shape, may be miniaturized, and may have a light weight. Therefore, lithium-ion polymer batteries have been widely used in mobile phones.

Conventional lithium-ion batteries used in mobile phones use graphite for the cathode. Even 2-10% nano silicon is added into the graphite, they are still difficult to exceed the energy density limit of 780 Wh/L. Also, the efficiency in the first use is low. Further, since the silicon-containing cathode may expand during the charging-discharging cycles, the cycle life of a conventional lithium-ion battery may be short. For example, the capacity retention rate may only be maintained higher than 80% for the first 100 to 300 cycles. Thus, conventional lithium-ion batteries may not be able to meet the need of the mobile phones for a higher energy density and a longer battery life time.

Moreover, a lithium-ion battery includes a separator. For a lithium-ion polymer battery, the polymer material used for the separator may be polyolefin, polyethylene oxide, polyacrylonitrile, polymethylmethacrylate (PMMA), or polyvinylidene difluoride (PVDF). However, these materials may reduce the uniformity of the cycles and the reliability, affecting the safety performance of the battery. Further, the choice of electrolyte may also affect the performance of the lithium-ion battery.

For at least the reasons discussed above, current lithium-ion polymer batteries used in mobile phones only have an energy density much lower than about 680 Wh/L and may maintain a capacity retention rate higher than 80% for only about 500 cycles.

The disclosed lithium-ion polymer batteries and their electronic devices are directed to solve one or more problems set forth above and other problems in the art.

### SUMMARY

One aspect of the present disclosure provides a lithium-ion polymer battery. The lithium-ion polymer battery includes a battery electrolyte. The battery electrolyte includes a solvent and an additive. The solvent includes propyl propionate and at least two selected from the group consisting of ethylene carbonate, diethyl carbonate, and propylene carbonate. The additive includes one or more ethylene sulfate, fluoroethylene carbonate, hexanedinitrile, ethylene glycol bis(propionitrile) ether, 1,3-propyl sultone, and fluorobenzene.

Another aspect of the present disclosure provides a lithium-ion polymer battery. The lithium-ion polymer battery includes a battery separator. The battery separator includes a base substrate; and an aqueous functional layer, compounded on a surface of the base substrate. The aqueous functional layer contains micropores and is a binder.

Another aspect of the present disclosure provides a lithium-ion polymer battery. The lithium-ion polymer battery includes graphite, a silicon-oxide-containing material, and a conductive agent.

Other aspects of the present disclosure can be understood by those skilled in the art in light of the description, the claims, and the drawings of the present disclosure.

### BRIEF DESCRIPTION OF THE DRAWINGS

FIG. 1 illustrates an example of a method for producing a lithium-ion battery separator according to some embodiments of the present disclosure;

FIG. 2 illustrates an example of a method for producing a lithium-ion polymer battery according to some embodiments of the present disclosure;

FIG. 3 illustrates a scanning electron microscope (SEM) image of a separator surface coating according to some embodiments of the present disclosure;

FIG. 4 illustrates an SEM image of another separator surface coating according to some embodiments of the present disclosure;

FIG. 5 illustrates an SEM image of a nano-ceramic coating on a separator according to some embodiments of the present disclosure;

FIG. 6 illustrates an SEM image of a polyvinylidene fluoride (PVDF) coating on a separator according to some embodiments of the present disclosure;

FIG. 7 illustrates an SEM image of another nano-ceramic coating on a separator according to some embodiments of the present disclosure;

FIG. 8 illustrates an SEM image of another polyvinylidene fluoride (PVDF) coating on a separator according to some embodiments of the present disclosure;

FIG. 9 illustrates an SEM image of a functional binder coating on a separator according to some embodiments of the present disclosure;

FIG. 10 compares cross-section deformation of jellyroll electrode-group of a battery before and after a cycle for both an experimental group and a control group according to some embodiments of the present disclosure;

FIG. 11 compares performance of batteries according to some embodiments of the present disclosure;

FIG. 12 illustrates a cycle performance according to some embodiments of the present disclosure;

FIG. 13 illustrates a curve for a storage thickness change rate at a high temperature of a battery according to some embodiments of the present disclosure;

FIG. 14 illustrates another cycle performance according to some embodiments of the present disclosure;

FIG. 15 illustrates a curve for another storage thickness change rate at a high temperature of a battery according to some embodiments of the present disclosure; and

FIG. 16 illustrates a residual capacity and a recovery capacity according to some embodiments of the present disclosure.

### DESCRIPTION OF EMBODIMENTS

Hereinafter, embodiments of the disclosure will be described with reference to the drawings, which are merely examples for illustrative purposes and are not intended to limit the scope of the disclosure. Wherever possible, the same reference numbers will be used throughout the drawings to refer to the same or like parts.

The embodiments described below are merely part rather than all of the embodiments of the disclosure. All other embodiments that may be derived by one of ordinary skill in the art based on the disclosed embodiments without inventive effort are within the scope of the disclosure.

Some embodiments of the disclosure include a lithium-ion polymer battery having a modified electrolyte composition and improved stability and lifetime. The disclosed lithium-ion battery may operate stably at a voltage of 4.40 V or 4.45 V, and may have an energy density of about 750 Wh/L or higher, a cycle life time of about 800 cycles or more, and a capacity retention rate of more than about 80%. As such, the life time of the lithium-ion battery with high voltage and high energy may be improved.

In some embodiments, the electrolyte may include a solvent and an additive.

The solvent may include propyl propionate (PP) and two or three materials selected from the group consisting of ethylene carbonate (EC), diethyl carbonate (DEC), and/or propylene carbonate (PC).

The additive may include ethylene sulfate (e.g., also named as 1,3,2-dioxathiolane 2,2-dioxide, DTD), fluoroethylene carbonate, hexanedinitrile, ethylene glycol bis(propionitrile) ether (DENE), 1,3-propyl sultone (PS), and/or fluorobenzene.

Based on a total solvent content of 100%, propyl propionate (PP) may have a content (or concentration or percentage) by volume of, e.g., about 10% to about 50%, such as about 10% to about 30%. In some embodiments, propyl propionate (PP) may have content by volume of, e.g., about 20%, about 30%, or about 40%.

Based on a total solvent content of 100% by volume, ethylene carbonate (EC) may have a content (or concentration or percentage) by volume of, e.g., about 10% to about 50%, such as about 10% to about 30%. In some embodiments, ethylene carbonate (EC) may have content by volume of, e.g., about 20%, about 30%, or about 40%.

Based on a total solvent content of 100%, diethyl carbonate (DEC) may have a content (or concentration or percentage) by volume of e.g., about 10% to about 50%, such as about 10% to about 30%. In some embodiments, diethyl carbonate (DEC) may have content by volume of, e.g., about 20%, about 30%, or about 40%.

Based on a total solvent content of 100%, propylene carbonate (PC) may have a content (or concentration or percentage) by volume of, e.g., about 10% to about 50%, such as about 10% to about 30%. In some embodiments, propylene carbonate (PC) may have content by volume of, e.g., about 20%, about 30%, or about 40%.

In some embodiments, the solvent may include propyl propionate (PP), ethylene carbonate (EC), diethyl carbonate (DEC), and propylene carbonate (PC) to provide a total volume content of 100%.

Consistent with the embodiments, the solvent of the electrolyte includes a mixture of propyl propionate (PP) with a cyclic carbonate such as ethylene carbonate (EC), a chain carbonate such as diethyl carbonate (DEC), and propylene carbonate (PC). Such a solvent has a better wettability with a cathode made of graphite and has a higher dielectric constant. It may reduce the resistivity to the lithium insertion in the cathode and improve the electrical conductivity. The disclosed solvent has a better operation temperature window and may facilitate to improve the stability of the cyclic performance of the battery.

Further, the compatibility of the disclosed solvent with the graphite cathode material may be significantly improved. In some embodiments, a stable solid electrolyte interphase (SEI) film may be formed on the surface of the graphite cathode. As such, the electrochemical stability of the battery may be improved and the oxidation potential may be increased.

As described above, the additive may include ethylene sulfate, fluoroethylene carbonate, hexanedinitrile, ethylene glycol bis(propionitrile) ether (DENE), 1,3-propyl sultone (PS), and/or fluorobenzene.

In some embodiments, the additive may further include at least one material selected from the group consisting of vinylene carbonate (VC) and succinonitrile (SN).

Using vinylene carbonate (VC) and/or succinonitrile (SN) in combination with other additives and the solvent, the cycle life, energy density, and high-temperature storing stability of the battery may be improved.

In some other embodiments, with respect to vinylene carbonate (VC) and succinonitrile (SN), other additives may be alternatively and/or additionally used. For example, at least one additive selected from the group consisting of vinylethylene carbonate (VEC), a polycyano-type additive, and a nitrile-type additive containing certain functional groups may be alternatively and/or additionally used, with respect to using vinylene carbonate (VC) and succinonitrile (SN).

In some embodiments, the additive may include ethylene sulfate, fluoroethylene carbonate, hexanedinitrile, ethylene glycol bis(propionitrile) ether (DENE), 1,3-propyl sultone (PS), fluorobenzene, vinylene carbonate (VC), and/or succinonitrile (SN).

The content by weight of ethylene sulfate may be about 0.1% to about 1.5%, such as about 0.5% to about 1.0%. The ethylene sulfate (or 1,3,2-dioxathiolane 2,2-dioxide DTD) added in the electrolyte may be decomposed on the surface of the cathode before ethylene carbonate (EC) is decomposed, forming an organic sulfonate having a desirable ion conductivity. This may reduce the interface impedance at the surface of the graphite in the cathode, reduce the internal resistance of the battery, and improve the cyclic performance of the battery.

The content by weight of the fluoroethylene carbonate (FEC) may be about 2% to about 10%, such as about 4% to about 8%.

By adding fluoroethylene carbonate (FEC) in the additive for the disclosed electrolyte, a ring-open polymerization may occur on the surface of the graphite anode to form a thinner SEI film, and to remarkably improve the battery cycle life.

The content by weight of vinylene carbonate (VC) may be about 0.1% to about 1%, such as about 0.3% to about 0.7%.

By adding vinylene carbonate (VC) in the additive for the electrolyte, a more stable and dense SEI film may be formed on the surface of the graphite anode, and may remarkably improve the battery cycle life.

The content by weight of succinonitrile (SN) may be about 1% to about 4%, such as about 2% to about 4%.

The content by weight of hexanedinitrile may be about 1% to about 4%, such as about 2% to about 4%.

The content by weight of ethylene glycol bis(propionitrile) ether (DENE) may be about 1% to about 4%, such as about 2% to about 3%.

The content by weight of 1,3-propyl sultone may be about 1% to about 5%, such as about 2% to about 3%.

The content by weight of fluorobenzene may be about 2% to about 10%, such as about 4% to about 8%.

By using succinonitrile (SN), ethylene glycol bis(propionitrile) ether (DENE), and 1,3-propyl sultone (PS) in the additive, a protective layer may be formed on the surface of high voltage cathode, which may be made of lithium cobalt oxide (LCO) in one example. For example, the group —CN may complex with Co having a high oxidation state to ensure a balance of charges on the cathode surface, which may effectively inhibit the dissolution of Co and decomposition of electrolyte on the cathode. Performance of high-voltage battery stability and high temperature storage, as well as the stability of the cycle life and thus the life of lithium-ion battery may be improved.

Any suitable lithium salts may be used in the disclosed electrolyte. For example, a lithium salt may be lithium hexafluorophosphate (LiPF6) having a concentration of about 1.0 mol/L to 1.3 mol/L.

In another example, the lithium salt may be lithium bis(trifluoromethane) sulfonimide (LiTFSI) or lithium bis(fluorosulfonyl)imide (LiFSI), having a concentration of about 0.1 mol/L to 0.5 mol/L.

For example, by mixing LiPF₆ with one or more of LiTFSI and LiFSI, interface impedance of the graphite anode may be improved. The solid electrolyte interface (SEI) film may be more stable and may significantly improve the battery cycle life.

In some embodiments, the “lithium-ion polymer battery” may have a collector coating material including: a carbon black (such as a SP carbon black), styrene-butadiene rubber (SBR) and/or hydroxymethylcellulose (CMC). The thickness of the coating material may be about 0.5 μm to about 2 μm.

The collector coating may include carbon black SP, SBR binder, and CMC dispersant to greatly improve the adhesion of collector coating with the graphite anode material and reduce the electrochemical impedance of the graphite anode under the high voltage and reduce the impurity of the reverse lithium. In addition, the collector coating may suppress the deterioration of the adhesion due to the cycle expansion, and may significantly improve the battery cycle life.

Any suitable cathode material, the anode material, and/or the separator may be used in the disclosed battery without limitation.

For example, the cathode material may be graphite, such as artificial graphite having a compacted density of about 1.70 g/cm³ to about 1.85 g/cm³.

The cathode material may be modified to improve the stability and service life time of the lithium-ion polymer battery.

For example, the cathode material may include one or more of graphite, silicon-oxide-containing material such as SiOx, and/or conductive agent(s).

By using the disclosed cathode, the lithium-ion battery may operate stably at a voltage of 4.40 V or 4.45 V, and may have an energy density of about 750 Wh/L or higher, a cycle life time of about 800 cycles or more, and a capacity retention rate of more than about 80%. As such, the life time of the lithium-ion battery with high voltage and high energy may be improved.

The graphite may be, for example, artificial graphite, such as artificial graphite as single crystal particles formed by secondary particle mixing.

Silicon-oxide-containing material such as SiOx, and/or conductive agent(s) may be added to the graphite material. For example, the silicon-oxide-containing material may be a three-dimensional network composite material where elementary substance Si and SiOx are uniformly dispersed, where x is from about 0.5 to about 1.5, and in certain embodiments, the x is from about 0.8 or about 1.1.

For example, the silicon-oxide-containing material may have a concentration by weight from about 10 wt % to about 50 wt %, such as from about 10 wt % to about 30 wt %, and in certain embodiments, the content is about 10 wt %, of a total cathode material.

For example, the conductive agent may be vapor-grown carbon fiber (VGCF) and/or carbon nanotubes (CNTs).

The content of the conductive agent may be, for example, from about 1 wt % to about 5 wt %, such as from about 1 wt % to about 3 wt %, and in certain embodiments, the content is about 1 wt %, of a total cathode material.

In some embodiments, the cathode material prepared by mixing SiOx a graphite while adding vapor-grown carbon fiber (VGCF) and/or carbon nanotubes (CNTs) as a conductive agent, may improve the gram specific capacity of the cathode material to about 600 mAh/g to about 1500 mAh/g. In addition, the fiber-like carbon nanotubes conductive network including VGCF and/or CNT enhances the electron conductivity of the (C+SiOx) cathode and reduces the cycles due to the expansion caused by the impedance changes, greatly improving the battery cycle life.

The stability and service life of lithium-ion polymer battery may be improved by modifying the battery separator.

The battery separator may include: a base substrate, an aqueous functional layer on the base substrate. The aqueous functional layer may have micropores and may also be a binder or otherwise have a binder function.

The disclosed lithium-ion polymer battery may be more stable and reliable in cycle performance, and may provide better safety performance and advantageous applications.

The base substrate of the battery separator may be made of any suitable separator material. In one embodiment, the base substrate may include a first surface and a second surface opposite to the first surface. In some embodiments, the base substrate may be a polyethylene (PE) film. The thickness of the base substrate may be from about 5 μm to about 20 μm, for example, from about 6 μm to about 10 μm.

The aqueous functional layer of the battery separator may be compounded on a surface of the base substrate. For example, materials of the aqueous functional layer and the base substrate may be chemically and/or physically reacted with one another to form a complex on the surface of the separator.

The aqueous functional layer may have micropores uniformly distributed to enable desirable conductance of lithium-ions. The aqueous functional layer may be a binder to allow adhesion between the internal electrode of the battery and the separator. In some embodiments, the separator or the aqueous functional layer compounded on an isolation film of the separator may have a large number of microporous passages with binder properties to allow adhesion between the internal electrode of the battery and the separator. As such, the electrode(s) may not be deformed and no gap may be generated at the interface, without affecting the lithium-ion conduction passages. Local lithium mining phenomenon may not occur. Deformation and expansion phenomenon may not occur to the battery electrode group during the charging-discharging cycle course, which is conducive to the stability of the cycle life.

The aqueous functional layer may be prepared from raw material(s) that are dispersible in water. The aqueous functional layer may have a large number of microporous passages. The aqueous functional layer does not have any requirements or does not need to control the hot pressing process and formation process after liquid infusion during preparation of the battery. The cycle performance of the battery is more stable and reliable, and the safety performance is improved. In addition, the raw material of the aqueous functional layer are water-dispersible and are not an oily or organic solvent such as acetone, and the micropores of the aqueous functional layer are evenly distributed and are not easily blocked by the electrolyte. The lithium-ion conduction passages are not affected. No environmental contamination is generated, while improving the consistency and reliability of the battery cycle performance.

In some embodiments, the aqueous functional layer has heat resistance and may improve the heat shrinkability of the separator when used in the disclosed lithium-ion polymer battery. The disclosed separator used in the lithium-ion polymer battery may allow that internal electrodes and the isolation film of the separator are not prone to deformation or being overly pulled to cause internal short-circuit, during a safety test or when the battery is undesirably needled/squeezed/twisted/bent and/or is used for long period of time at high temperatures. Even in the case that the short circuit occurs internally, as the heat shrinkable area of the isolation film of is hard to expand, safety performance of the disclosed battery may be greatly improved.

In some embodiments, the aqueous functional layer includes an inorganic nano-ceramic layer and an aqueous functional binder layer. The inorganic nano-ceramic layer and the aqueous functional binder layer may be compounded on a same side or different side of the base substrate.

In some embodiments, the inorganic nano-ceramic layer and the aqueous functional binder layer may be compounded on at least one surface of the base substrate, and may form a laminated composite. In one embodiment, the inorganic nano-ceramic layer is compounded on one surface of the base substrate, and the aqueous functional binder layer may be compounded on another one surface of the inorganic nano-ceramic layer. The inorganic nano-ceramic layer may have a thickness of about 2 μm to about 5 μm, and the inorganic functional layer may have a thickness of about 0.5 μm to about 2 μm.

In other embodiments, the base substrate may have a first surface compounded to form the inorganic nano-ceramic layer thereon, and may have a second surface compounded to form the aqueous functional binder layer thereon. The inorganic nano-ceramic layer may have a thickness of about 2 μm to about 5 μm, and the aqueous functional binder layer may have a thickness of about 0.5 μm to about 2 μm.

In some embodiments, the inorganic nano-ceramic layer is made of a material containing inorganic nano-ceramics including, for example, alumina (Al₂O₃) nano-ceramics and/or magnesium hydroxide (Mg(OH)₂). The aqueous functional binder layer may be made of a material containing an aqueous functional binder including, for example, aqueous functional binders supplied by AFL, polyvinylidene fluoride (PVDF), and/or polymethylmethacrylate (PMMA). In one embodiment, the aqueous functional binder layer is an aqueous functional binder (AFL) or polyvinylidene fluoride (PVDF).

In some embodiments, the inorganic nano-ceramic materials used for the separator may have desirable heat resistance and may improve the heat shrinkability of the separator when used in the disclosed lithium-ion polymer battery. The bonding of inorganic nano-ceramic layer with the aqueous functional binder layer may provide adhesion between the separator and the electrode(s) to thus allow internal electrodes and the separator not to prone to deformation or being overly pulled to cause internal short-circuit, during a safety test or when the battery is undesirably needled/squeezed/twisted/bent and/or is used for long period of time at high temperatures. Even in the case that the short circuit occurs internally, as the heat shrinkable area of the isolation film of is hard to expand, safety performance of the disclosed battery may be greatly improved. In addition, the aqueous functional layer formed on the separator has a large amount of microporous passages and does not have any requirements or need to control the hot pressing process and formation process after liquid infusion during preparation of the battery. There is no need to concern about dissolving and clogging of the electrolyte into the binder layer. The cycle performance of the battery is more stable and reliable, and the safety performance is improved without having any environmental contaminations.

In other embodiments, the aqueous functional layer is a mixed material layer made of a material including an inorganic nano-ceramic material and an aqueous functional binder material. The base substrate may include at least one surface having the mixed material layer. The inorganic nano-ceramic includes one or more of alumina (Al₂O₃) nano-ceramics and magnesium hydroxide (Mg(OH)₂) nano-ceramics. In one embodiment, the inorganic nano-ceramic material is alumina nano-ceramic. The aqueous functional binder may be one or more of the aqueous functional binder (AFL), polyvinylidene fluoride (PVDF), and polymethylmethacrylate (PMMA). For example, the aqueous functional binder is the aqueous functional binder (AFL) or polyvinylidene fluoride (PVDF).

The mixed material layer may be compounded on one or two sides of the base substrate and may have a thickness of about 1 μm to about 5 μm. In one embodiment, the proportion of the inorganic nano-ceramics in the mixed material layer may be greater than about 70%. As disclosed, the separator having the mixed material layer on the surface may improve the safety performance of the battery.

The aqueous functional layer may be compounded on surface of the base substrate, e.g., by a coating method or any method capable of forming a coating layer. For example, a method for producing a lithium-ion battery separator may include the following.

An inorganic nano-ceramic slurry and an aqueous functional binder slurry may be respectively coated on one or two sides of the base substrate and dried to form an inorganic nano-ceramic layer and an aqueous functional binder layer, respectively, to obtain a lithium-ion battery separator. The aqueous functional binder slurry may include aqueous functional binder and water.

Alternatively, inorganic nano-ceramic slurry and the aqueous functional binder slurry may be mixed to form mixed slurries coated on one or two sides of the base substrate and dried to form a mixed material layer to obtain a lithium-ion battery separator. The mixed slurries may include an inorganic nano-ceramic, an aqueous functional binder, and water.

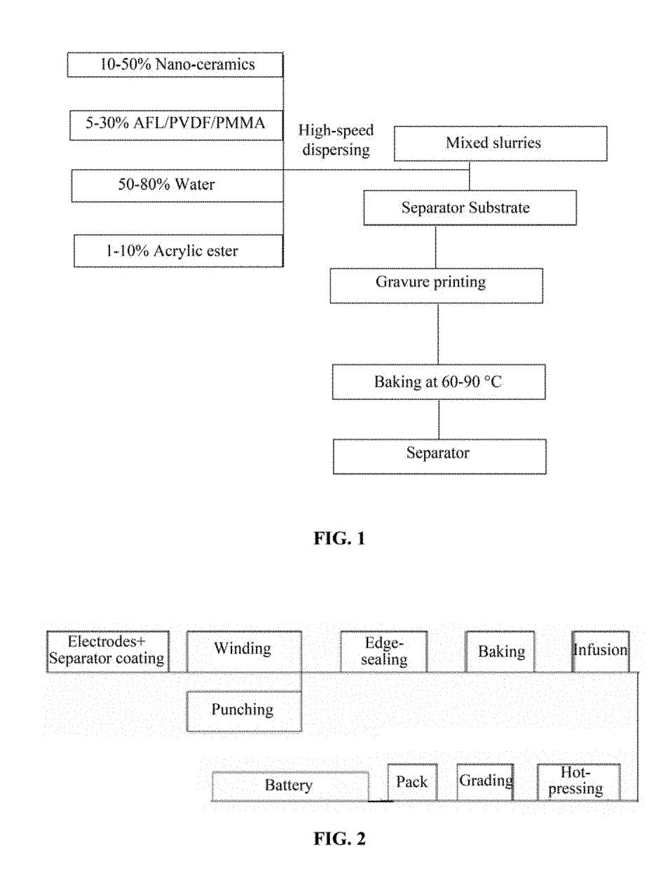

FIG. 1 illustrates an example of a process for producing a lithium-ion battery separator according to some embodiments of the present disclosure. In one embodiment, mixed slurries may be coated on one or two sides of a base substrate, e.g., by a gravure process, and baked to form a separator. The mixed slurries may include an inorganic nano-ceramic, an aqueous functional binder, and/or water.

In some embodiments, by weight or by mass, the mixed slurries may include about 10% to about 50%, such as about 15% to about 40% of inorganic nano-ceramics, about 5% to about 30% of an aqueous functional binder, about 40% to about 80% of water, and about 1% to about 10% of an acrylic ester. The inorganic nano-ceramic may include inorganic nano-ceramic powder/particles, for example, having a particle size of about 0.1 μm to about 1 μm.

In one embodiment, the mixed slurries may include about 8% to about 25% of an aqueous functional binder, including those commercially available binders. The mixed slurries may include about 50% to about 80% of water, so that the inorganic nano-ceramic and aqueous functional binder are uniformly dispersed in the water solvent, which will not generate any environment contaminations. The mixed slurries may include about 3% to 8% of the acrylic ester used to disperse and stabilize the nano-ceramic particles and to facilitate bonding between ceramic particles and between the ceramic particles and the separator. By mixing the above-described materials, the mixed slurries may be prepared by a uniform dispersion at a high linear velocity of more than about 20 m/s such as about 25 m/s.

The mixed slurries may be coated on the base substrate and then dried to form a mixed material layer, i.e., a mixed coating, to obtain a lithium-ion battery separator. Any suitable coating methods may be used and included in the present disclosure including, for example, a gravure printing method may be used. The drying process may be a baking process, e.g., at a baking temperature of about 60° C. to about 90° C. The resulting separator may be coated on one side or two sides with the mixed coating having a thickness on each side of about 1 μm to about 5 μm.

Alternatively, the inorganic nano-ceramic slurry and aqueous functional binder slurry may be respectively coated on one or two sides of the base substrate and dried to obtain a lithium-ion battery separator. The aqueous functional binder slurry may include an aqueous functional binder and water.

In some embodiments, by weight (or by mass), the inorganic nano-ceramic slurry may include about 10% to about 50% of inorganic nano-ceramic, about 40% to about 80% of water, and about 1% to about 10% of acrylic ester. The aqueous functional slurry may include about 10% to about 30% of aqueous functional binder, about 60% to about 80% water, and about 1% to about 10% acrylic ester. By mixing with respective components at a high linear velocity of greater than 20 m/s, such as about 25 m/s, the inorganic nano-ceramic slurry and the aqueous functional binder slurry may be respectively produced.

In some embodiments, the inorganic nano-ceramic slurry and the aqueous functional binder slurry may be respectively coated on two sides of the base substrate, and dried to respectively form an inorganic nano-ceramic layer and an aqueous functional binder layer, to thus obtain a lithium-ion battery separator. In other embodiments, the inorganic nano-ceramic slurry may be coated on one surface of the base substrate to form a nano-ceramic coating. The aqueous functional binder slurry may be coated on the formed nano-ceramic coating to form a functional binder coating to obtain a lithium-ions battery separator.

Any suitable coating methods may be used and included in the present disclosure including, for example, a gravure printing may be used. The drying process may be a baking process, e.g., at a baking temperature of about 60° C. to about 90° C. In some embodiments, the thickness of the nano-ceramic coating may be about 2 μm to about 5 μm, and the thickness of the functional binder coating may be about 0.5 μm to about 2 μm.

The aqueous functional binder and the inorganic nano-ceramic may be dispersed in water, and either mixedly coated or separately to form an aqueous coating having a large number of microporous passages and to bond the electrodes with the separator. The lithium-ion conduction passages are not affected and the separator has good performance. Safety performance of the battery may be improved. In addition, there are no requirements or no need to control the hot pressing process and formation process after liquid infusion during preparation of the battery. There is no need to concern about dissolving and clogging of the electrolyte into the binder coating. The cycle performance of the battery is more stable and reliable, and the safety performance is improved without having any environmental contaminations.

After forming the disclosed separator, a lithium-ion polymer battery may be prepared by: sequentially winding and sealing the electrode and the separator, followed by a baking process. Electrolyte may then be infused there-into and subjected to a hot pressing process to obtain a lithium-ion polymer battery.

FIG. 2 illustrates an example of a method for preparing a lithium-ion polymer battery according to some embodiments of the present disclosure. In one embodiment, the electrode plate and the above coated separator may be winded and edge-sealed on the top and side by an aluminum-plastic film punching process, followed by processes including baking, infusion, hot pressing, formation, grading, and/or packaging, to provide a battery.

Any electrode plate may be used in the disclosed battery. Any suitable process of winding, edge-sealing, and the like may be used according to various embodiments of the present disclosure. For example, a baking temperature may be about 80° C. to about 90° C. for about 20 hours.

After the baking process, the electrolyte may be infused and then subjected to the hot-pressing process to form the lithium-ion polymer battery.

In one embodiment, the hot pressing temperature may be about 80° C. to about 90° C., for example, about 85° C. The hot pressing time may be about 1 hour to about 2 hours. As disclosed herein, the hot pressing process may facilitate better bonding between the internal battery and the separator. As such, the electrode(s) may not be deformed and no gap may be generated at the interface, without affecting the lithium-ion conduction passages. Local lithium mining phenomenon may not occur. Deformation and expansion phenomenon may not occur to the battery electrode group during the cycle course, which is conducive to the stability of the cycle life.

In some embodiments, the inorganic nano-ceramic materials used for the separator may have desirable heat resistance and may improve the heat shrinkability of the separator when used in the disclosed lithium-ion polymer battery. The bonding of inorganic nano-ceramic layer with the aqueous functional binder layer may provide adhesion between the separator and the electrode(s) to thus allow internal electrodes and the separator not to prone to deformation or being overly pulled to cause internal short-circuit, during a safety test or when the battery is undesirably needled/squeezed/twisted/bent and/or is used for long period of time at high temperatures. The heat shrinkable area of the separator is thus hard to expand, and the safety performance of the disclosed battery may be greatly improved.

After the hot pressing process, a lithium-ion polymer battery may be produced by processes including formation, grading, packaging, etc. The prepared lithium-ion polymer batteries were tested and measured, for example, based on the national standard GB 31241-2014 (China) <Safety Requirements of Lithium-Ion Battery and Battery Pack for Portable Electronic Products>. The results show that the lithium lithium-ion battery produced according to the present disclosure has a more stable and reliable cycle performance and improved safety performance.

As disclosed herein, the lithium-ion polymer battery may include one or more of the above described; electrolyte, battery separator (or separator), and cathode, each of which is different from or at least is modified to provide the battery with improved stability and better service life.

The present disclosure also provides an electronic device including the disclosed lithium lithium-ion battery. The electronic device may be, for example, a smart phone, a computer, and/or as computer-controlled: robot, CNC system, and/or program control system.

For illustration purposes, the following are examples of lithium-ion polymer batteries and/or electronic devices described in detail and provided in the present disclosure.

In the following examples, the base substrate was PE, having a thickness of about 7 μm (PE 7 μm, purchased from SK Co., Ltd., Korea). The nano-ceramic powder/particles having particle size of about 0.7 μm and the acrylic ester were purchased from ZEON Co., Ltd., Japan.

### EXAMPLE 1

By weight, about 10% alumina nanopowder, about 30% aqueous fiber binder AFL (model BM-2509, purchased from ZEON, Japan), about 1% acrylic ester, and about 59% water were mixed and uniformly dispersed at a linear velocity of about 25 m/s, providing mixed slurries.

The mixed slurries were coated on one side of a base substrate by a gravure printing process and baked at a temperature of about 90° C. to form a lithium-ion battery separator having a thickness of about 3 μm.

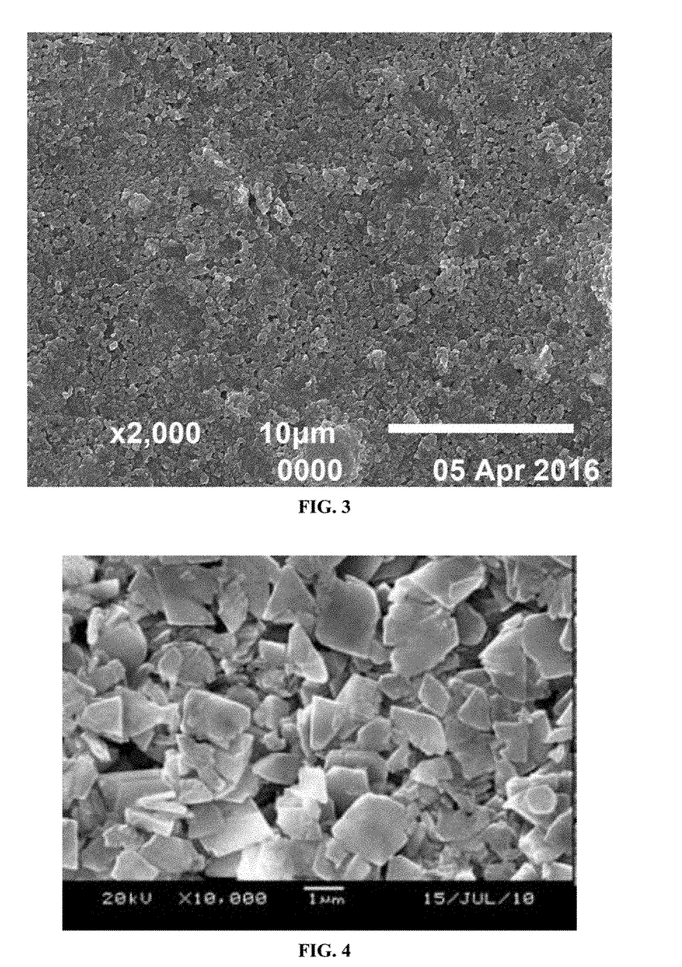

Scanning electron microscopy (SEM) was used to scan the coating. Accordingly, FIG. 3 illustrates an SEM image of separator surface coating.

### EXAMPLE 2

By weight, about 50% of the magnesium hydroxide nano-ceramic powder, about 5% of the polymethylmethacrylate (PMMA) (model LA133, purchased from Chengdu, China), about 10% of the acrylic ester, and about 35% of the water were mixed and uniformly dispersed at a linear velocity of about 25 m/s, providing a mixed slurries.

The mixed slurries were coated on two sides of a base substrate by a gravure printing process and baked at a temperature of about 60° C. to form a lithium-ion battery separator having a thickness of about 3 μm.

SEM was used to scan the coating. Accordingly, FIG. 4 illustrates an SEM image of separator surface coating.

### EXAMPLE 3

By weight, about 40% alumina nanopowder, about 5% acrylic ester, and about 55% water were mixed and uniformly dispersed at a linear velocity of about 25 m/s, providing inorganic nano-ceramic slurry. About 10% polyvinylidene fluoride (PVDF) (model LBG, purchased from Arkema, Japan), about 10% of the acrylic ester, and about 80% of the water were mixed and uniformly dispersed at a linear velocity of about 25 m/s, providing an aqueous functional binder slurry.

The inorganic nano-ceramic slurry and the aqueous functional binder slurry was respectively coated on two sides of a base substrate by a gravure printing process and baked at a temperature of about 70° C. to form a lithium-ion battery separator. In the lithium-ion battery separator, a thickness of the nano-ceramic coating was about 3 μm and a thickness of the functional binder coating was about 1 μm.

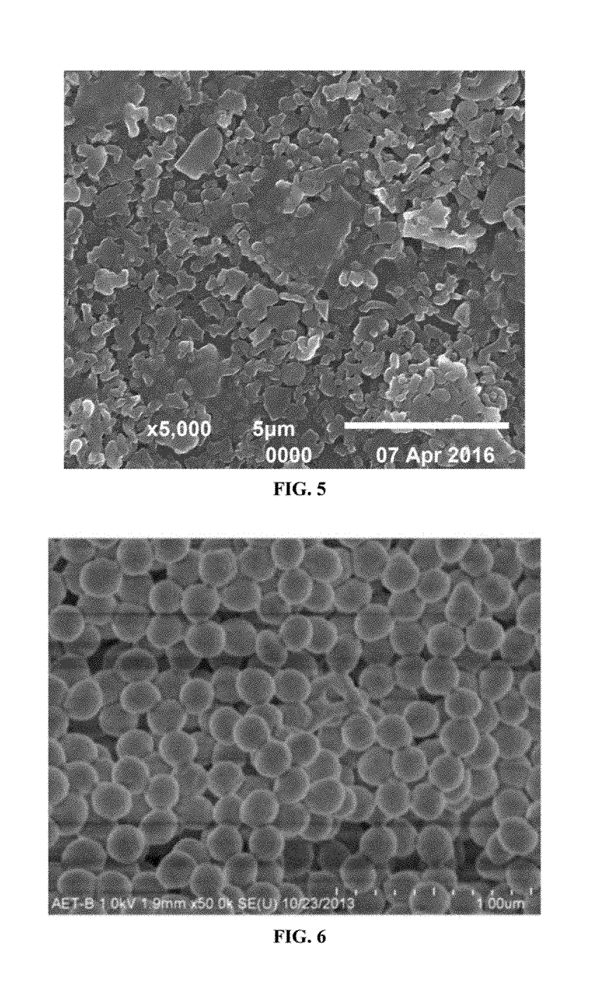

The nano-ceramic coating and the functional binder coating were analyzed by SEM. The SEM images are shown in FIG. 5 and FIG. 6, respectively. FIG. 5 is an SEM image of the nano-ceramic coating on separator surface provided in Example 3. FIG. 6 is an SEM image of a polyvinylidene fluoride (PVDF) coating on the separator surface provided in Example 3.

### EXAMPLE 4

By weight, about 30% magnesium hydroxide nano-ceramic powder, about 8% acrylic ester, and about 62% water were mixed and uniformly dispersed at a linear velocity of about 25 m/s, providing inorganic nano-ceramic slurry. About 25% of polyvinylidene fluoride (PVDF) (model LBG, purchased from Arcoema, Japan), about 5% of the acrylic ester, and about 70% of the ater were mixed and uniformly dispersed at linear velocity of about 25 m/s, providing aqueous functional binder slurry.

The inorganic nano-ceramic slurry and the aqueous functional binder slurry were coated on two sides of the base substrate by a gravure printing process and baked at a temperature of 80° C. to obtain a lithium-ion battery separator. In the lithium-ion battery separator, a thickness of the nano-ceramic coating was about 3 μm and a thickness of the functional binder coating was about 1 μm.

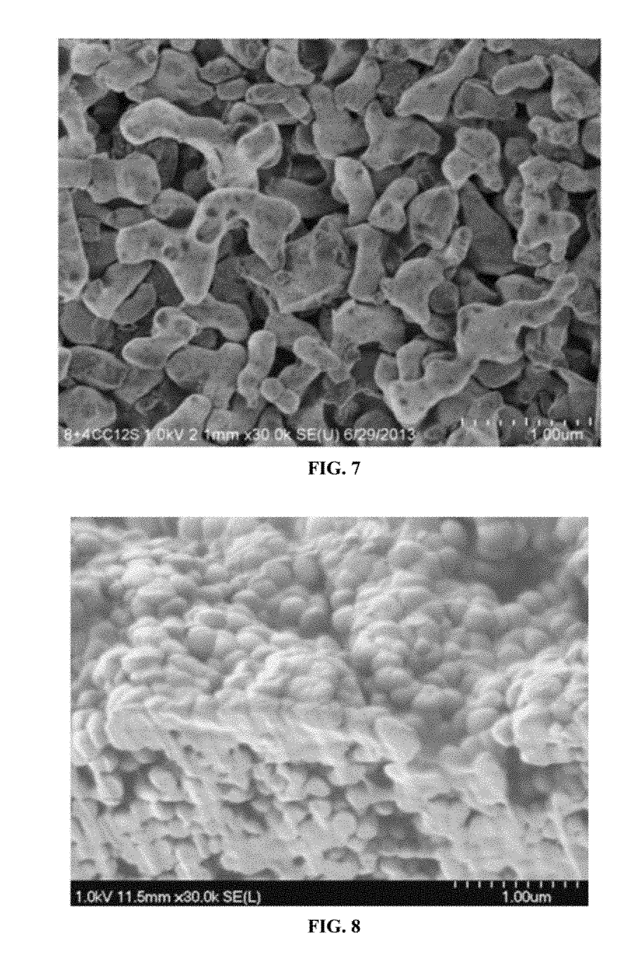

The nano-ceramic coating and the functional binder coating were analyzed by SEM. The SEM images are shown in FIG. 7 and FIG. 8, respectively. FIG. 7 is an SEM image of the nano-ceramic coating on separator surface provided in Example 4. FIG. 8 is an SEM image of a polyvinylidene fluoride (PVDF) coating on the separator surface provided in Example 4.

### EXAMPLE 5

By weight, about 20% of the alumina nanopowder, about 3% of the acrylic ester, and about 77% of the water were mixed and uniformly dispersed at a linear velocity of about 25 m/s, providing inorganic nano-ceramic slurry. About 20% aqueous functional binder AFL (model BM-2509, purchased from ZEON Japan), about 8% of the acrylic ester, and 72% of the water were mixed were mixed and uniformly dispersed at a linear velocity of about 25 m/s, providing an aqueous functional binder slurry.

The inorganic nano-ceramic slurry was coated on one side of a base substrate by a gravure printing process, baked at a temperature of 65° C. to form a nano-ceramic coating, and then the aqueous functional binder slurry was coated by a gravure printing process on a surface of the nano-ceramic coating, to form a lithium-ion battery separator, in which the thickness of the nano-ceramic coating was 3 μm and the thickness of the functional binder coating was 1 μm.

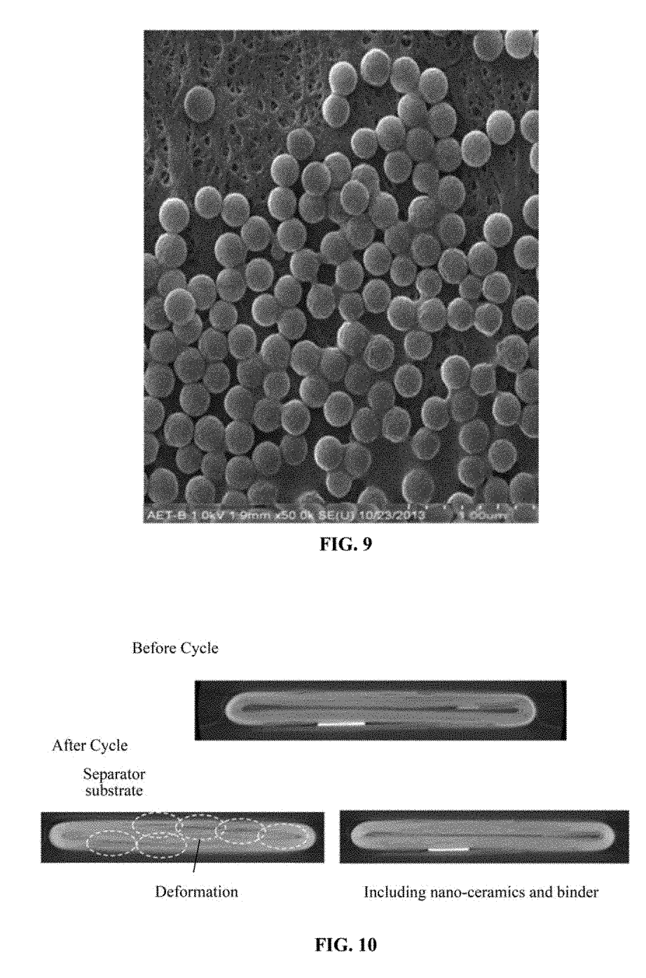

The functional binder coating was scanned and examined by using SEM. The SEM image is shown in FIG. 9. FIG. 9 is an SEM image of functional binder AFL coating on the separator surface provided in Example 5.

### EXAMPLE 6

The LCO anode electrode (HCV-15D, purchased from Tianjin Baimo Company, China), graphite cathode electrode (G1, purchased from Jiangxi Zichen Company, China), and the separator prepared in Example 1 were winded and edge-sealed on the top and side by an aluminum-plastic film punching process, followed by a baking process at a temperature of 85° C. for about 20 hours. The electrolyte (LBC-3045M, purchased from Xinzhoubang Company, China) were infused, followed by processes including hot pressing, formation, grading, and/or packaging, to provide a lithium-ion polymer battery. The hot pressing process was conducted at a temperature of 85° C. for about 1 hour.

Performance of the prepared lithium-ion polymer batteries was tested according to the national standard GB 31241-2014 (China) <Safety Requirements of Lithium-Ion Battery and Battery Pack for Portable Electronic Products>. The tested results are shown in Table 1. Table 1 includes performance test results of lithium-ion battery produced according to Example 1.

TABLE 1

| | | Sample | |
|---|---|---|---|
| Test Type | Test Conditions | (pcs) | Result/Status |
| Electrical | Cycle life at 25° C. | 3 | Capacity retention rate |
| performance | | | after 500 cycles > 80% |
| | Cycle life at 45° C. | 3 | Capacity retention rate |
| | | | after 500 cycles > 80% |
| | Discharge rate: | 3 | 1 C capacity > 0.2 C |
| | 0.2 C/0.5 C/1.0 C/1.5 C | | capacity*97% |
| Storage | 85° C. for 6 hours | 3 | Thickness expansion < |
| performance | | | 10% |
| | 60° C. for 15 days | 3 | Thickness expansion < |
| | | | 10% |
| Safety | Overcharge performance | 3 | Pass |
| performance | Room temperature | 3 | Pass |
| | external short-circuit | | |
| | performance | | |
| | High temperature | 3 | Pass |
| | external short-circuit | | |
| | performance | | |
| | Thermal shock | 3 | Pass |
| | performance at 130° C. | | |

Table 1 includes an experimental group of the battery prepared in Example 1. Accordingly, a control group included batteries prepared by using a base substrate to replace the product obtained from Example 1.

FIG. 10 in Example 6 illustrates comparison of cross-section deformation of jellyroll electrode-group of the battery before and after the cycle for both the experimental group and the control group. As indicated from FIG. 10, serious deformation occurred to the control group, while no deformation occurred to the experimental group.

### EXAMPLE 7

The LCO anode electrode (HCV-15D, purchased from Tianjin Baimo Company, China), graphite cathode electrode (G1, purchased from Jiangxi Zichen Company, China), and the separator prepared in Example 2 were winded and edge-sealed on the top and side by an aluminum-plastic film punching process, followed by a baking process at a temperature of 85° C. for about 20 hours. The electrolyte (LBC-3045M, purchased from Xinzhoubang Company) were infused, followed by processes including hot pressing, formation, grading, and/or packaging, to provide a lithium-ion polymer battery. The hot pressing process was conducted at a temperature of 85° C. for about 1 hour.

Performance test of the prepared lithium-ion polymer batteries was tested as discussed above in Example 6. The tested results are shown in Table 2. Table 2 of Example 7 includes performance test results of lithium-ion battery produced according to Example 2.

TABLE 2

| | | Sample | |
|---|---|---|---|
| Test Type | Test Conditions | (pcs) | Result/Status |
| Electrical | Cycle life at 25° C. | 3 | Capacity retention rate |
| performance | | | after 500 cycles > 85% |
| | Cycle life at 45° C. | 3 | Capacity retention rate |
| | | | after 500 cycles > 82% |
| | Discharge rate: | 3 | 1 C capacity > 0.2 C |
| | 0.2 C/0.5 C/1.0 C/1.5 C | | capacity*97.5% |
| Storage | 85° C. for 6 hours | 3 | Thickness expansion < |
| performance | | | 10% |
| | 60° C. for 15 days | 3 | Thickness expansion < |
| | | | 10% |
| Safety | Overcharge performance | 3 | Pass |
| performance | Room temperature | 3 | Pass |
| | external short-circuit | | |
| | performance | | |
| | High temperature | 3 | Pass |
| | external short-circuit | | |
| | performance | | |
| | Thermal shock | 3 | Pass |
| | performance at 130° C. | | |

### COMPARATIVE EXAMPLE 1

By weight, about 30% alumina nanopowder, about 5% acrylic ester, and about 65% water were mixed and uniformly dispersed at a linear velocity of about 25 m/s, providing an inorganic nano-ceramic slurry.

By weight, about 3% oily functional binder (Model 2801, purchased from Arkema, Japan), about 97% acetone were mixed and uniformly dispersed at a linear velocity of about 25 m/s, providing an oily functional binder slurry.

The inorganic nano-ceramic slurry was coated on one side of a base substrate by a gravure printing process and baked at a temperature of about 90° C. to form a nano-ceramic coating having a thickness of about 3 μm. The oily functional binder slurry may be coated on the nano-ceramic coating by a dip coating process and baked at a temperature of about 90° C. to form a functional binder coating having a thickness of about 2 μm. A lithium-ion battery separator may thus be formed including the functional binder coating on the nano-ceramic coating, which is formed on the base substrate.

The LCO anode electrode (HCV-15D, purchased from Tianjin Baimo Company, China), graphite cathode electrode (G1, purchased from Jiangxi Zichen Company, China), and the prepared separator in this Example were winded and edge-sealed on the top and side by an aluminum-plastic film punching process, followed by a baking process at a temperature of 85° C. for about 20 hours. The electrolyte (LBC-3045M, purchased from Xinzhoubang Company) were infused, followed by processes including hot pressing, formation, grading, and/or packaging, to provide a lithium-ion polymer battery. The hot pressing process was conducted at a temperature of 85° C. for about 1 hour.

### EXAMPLE 8

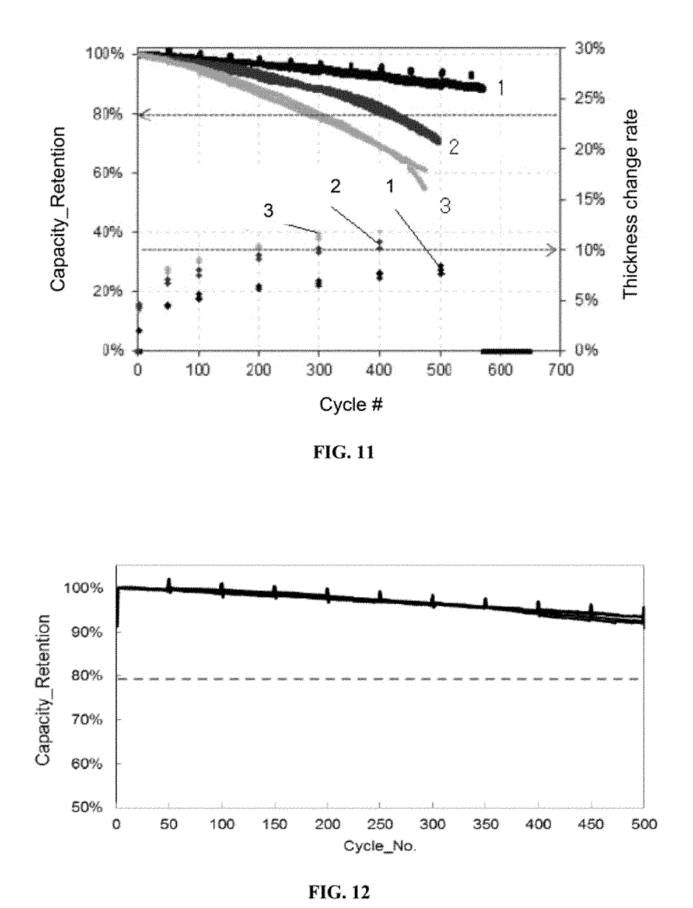

Performance of the battery produced in Comparative Example 1 was compared with the battery produced in experimental group of Example 6. The performance was tested based on the national standard GB 31241-2014 (China) <Safety Requirements of Lithium-Ion Battery and Battery Pack for Portable Electronic Products>. The test conditions included a 0.7 C/0.5 C cycle at 25° C. The test results are shown in FIG. 11. FIG. 11 shows comparison results between the battery obtained the experimental group in Example 6, the base substrate in control group in Example 6, and the battery obtained in Comparative Example 1.

In FIG. 11, Curve 1 shows a capacity retention rate curve of the battery including a separator, having an aqueous/nano-ceramic and a functional binder in the experimental group of Example 6. Curve 2 shows a capacity retention rate curve of the battery including a separator, having an oil/nano-ceramic and functional binder in Comparative Example 1. Curve 3 shows a capacity retention curve of the base substrate in the control group of Example 6 with no coatings.

As indicated from FIG. 11, the experimental group of Example 6 had a capacity retention rate of more than about 80% after 500 cycles, and the cell thickness change rate was less than about 10%, all of which were superior to that of the battery obtained in Comparative Example 1. Battery performance for the control group of Example 6 had the capacity retention rate of less than about 80% at the 300th cycle, and had the thickness change rate much higher than 10%.

As disclosed, to form a separator, the inorganic nano-ceramic layer and the aqueous functional binder layer may be provided on either one side or two sides of the base substrate surface. Alternatively, materials for the inorganic nano-ceramic layer and the aqueous functional binder layer may be mixed to form a mixed material layer on either one side or two sides of the base substrate surface. The disclosed separator may be used for a lithium-ion polymer battery and may allow adhesion between the internal electrode of the battery and the separator. As such, the electrode(s) may not be deformed and no gap may be generated at the interface, without affecting the lithium-ion conduction passages. Local lithium mining phenomenon may not occur. Deformation and expansion phenomenon may not occur to the battery electrode group during the cycle course, which is conducive to the stability of the cycle life.

In addition, the inorganic nano-ceramic materials used for the separator may have desirable heat resistance and may improve the heat shrinkability of the separator when used in the disclosed lithium-ion polymer battery. The bonding of inorganic nano-ceramic layer with the aqueous functional binder layer may provide adhesion between the separator and the electrode(s) to thus allow internal electrodes and the separator not to prone to deformation or being overly pulled to cause internal short-circuit, during a safety test or when the battery is undesirably needled/squeezed/twisted/bent and/or is used for long period of time at high temperatures. Even in the case that the short circuit occurs internally, as the heat shrinkable area of the isolation film of is hard to expand, safety performance of the disclosed battery may be greatly improved.

In addition, the aqueous functional layer formed on the separator has a large amount of microporous passages and does not have any requirements or need to control the hot pressing process and formation process after liquid infusion during preparation of the battery. There is no need to concern about dissolving and clogging of the electrolyte into the binder layer. The cycle performance of the battery is more stable and reliable, and the safety performance is better without having any environmental contaminations and easier for applications.

### EXAMPLE 9

To prepare a lithium-ion polymer battery, the cathode material included: artificial graphite mixed with about 10% SiO_{0.8} by weight, and further added with about 1%, by weight, conductive agent including carbon nanofiber, such as vapor-grown carbon fiber (VGCF).

The electrolyte solvent included: about 30% ethylene carbonate (EC), about 30% DEC (diethyl carbonate), and about 40% propyl propionate (PP), by volume of the total solvent.

The electrolyte lithium salts included: about 1.00 M LiPF6 and about 0.20 M LiTFSI.

The additives included: about 10% fluoroethylene carbonate (FEC), about 0.5% ethylene sulfate (DTD), about 0.5% vinylene carbonate (VC), about 2% succinonitrile (SN), about 2% hexanedinitrile (ADN), about 2% diol glycol bis(propionitrile) ether (DENE), about 2% 1,3-propyl sultone (PS), and/or about 4% fluorobenzene.

Copper collector had a coating material including carbon black, SBR binder, and CMC dispersant to form a mixed coating having a coating thickness of about 1 μm.

Anode material was lithium cobalt oxide (LCO) (LC9000H, purchased from Hunan Shanshan Advanced Material Co., Ltd., China).

The base substrate of the separator was made of PE, having a thickness of about 7 μm (PE 7 μm, purchased from SK Co., Ltd., Korea).

Performance tests were performed for the prepared lithium-ion polymer batteries. Three groups of the battery samples were tested in parallel. Table 3 illustrates performance test results at a high voltage of 4.40V, and Table 4 illustrates performance tests at a high voltage of 4.45V. The test methods and conditions were based on the national standard GB 31241-2014 (China).

TABLE 3

| | | Sample | |
|---|---|---|---|
| Test Type | Test Conditions | (pcs) | Result/Status |
| Electrical | Cycle life at 25° C. | 3 | Capacity retention rate |
| performance | | | after 500 cycles > 80% |
| | Cycle life at 45° C. | 3 | Capacity retention rate |
| | | | after 500 cycles > 80% |
| | Discharge rate: | 3 | 1 C capacity > 0.2 C |
| | 0.2 C/0.5 C/1.0 C/1.5 C | | capacity*97% |
| Storage | 85° C. for 6 hours | 3 | Thickness expansion < |
| performance | | | 10% |
| | 60° C. for 15 days | 3 | Thickness expansion < |
| | | | 10% |
| Safety | Overcharge performance | 3 | Pass |
| performance | Room temperature | 3 | Pass |
| | external short-circuit | | |
| | performance | | |
| | High temperature | 3 | Pass |
| | external short-circuit | | |
| | performance | | |
| | Thermal shock | 3 | Pass |
| | performance at 130° C. | | |

As indicated in Table 3 and Table 4, the prepared lithium-ion polymer batteries under a high voltage of 4.40V and 4.45V provided performance stability and performance enhancement.

TABLE 4

| | | Sample | |
|---|---|---|---|
| Test Type | Test Conditions | (pcs) | Result/Status |
| Electrical | Cycle life at 25° C. | 3 | Capacity retention rate |
| performance | | | after 500 cycles > 80% |
| | Cycle life at 45° C. | 3 | Capacity retention rate |
| | | | after 500 cycles > 80% |
| | Discharge rate: | 3 | 1 C capacity > 0.2 C |
| | 0.2 C/0.5 C/1.0 C/1.5 C | | capacity*97% |
| Storage | 83° C. for 6 hours | 3 | Thickness expansion < |
| performance | | | 10% |
| | 60° C. for 15 days | 3 | Thickness expansion < |
| | | | 10% |
| Safety | Overcharge performance | 3 | Pass |
| performance | Room temperature | 3 | Pass |
| | external short-circuit | | |
| | performance | | |
| | High temperature | 3 | Pass |
| | external short-circuit | | |
| | performance | | |
| | Thermal shock | 3 | Pass |
| | performance at 130° C. | | |

Further, the energy density in the 4.40V system is greater than about 750 Wh/L. while the energy density in the 4.45V system is greater than about 820 Wh/L.

Cycle life tests were performed under 4.45-3.00V at 25° C. for 500 times of 0.5 C/1 C cycles. Three groups of sample were taken and tested in parallel. FIG. 12 illustrates a cycle performance according to Example 9. As indicated in FIG. 12, after being cycled for 500 times, the batteries had a capacity retention rate of greater than about 80%.

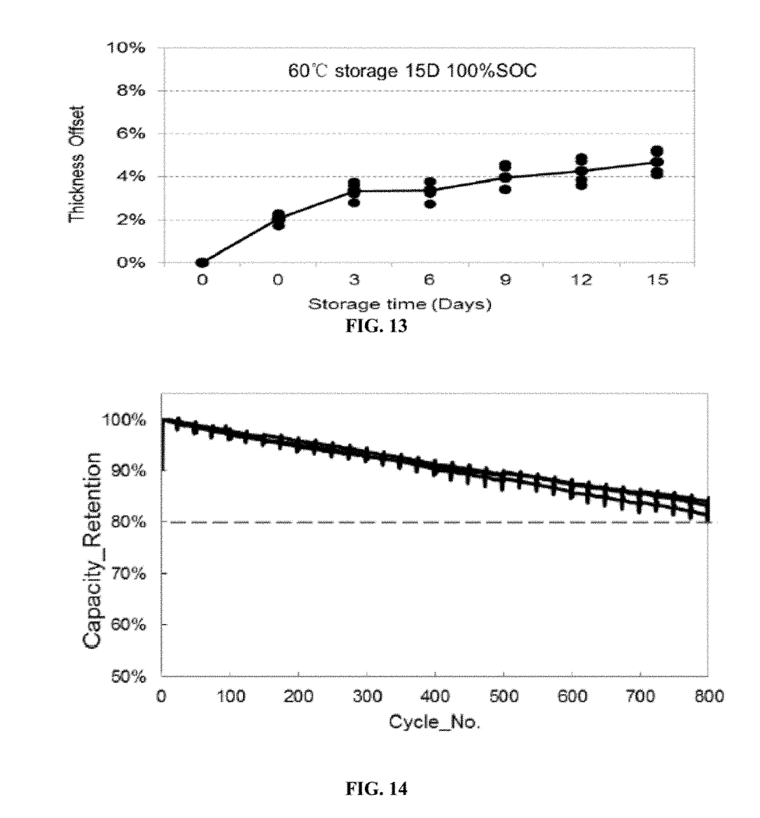

Storage stability at high temperatures was also tested for the prepared lithium-ion polymer batteries. The prepared batteries were stored at a temperature of 60° C. for 15 days. Three groups of samples were tested in parallel. FIG. 13 illustrates storage thickness change rate at a high temperature of batteries prepared in Example 9. As shown, after stored at a high temperature for about 15 days, the thickness change rate is lower than about 6%, indicating the prepared lithium-ion polymer batteries have storage stability at high temperatures.

### EXAMPLE 10

To prepare a lithium-ion polymer battery, the cathode material included: artificial graphite mixed with about 10% SiO_{1.1} by weight, and further added with about 1% by weight, conductive agent including CNT.

The electrolyte solvent included: about 30% ethylene carbonate (EC), about 30% diethyl carbonate (DEC), and about 40% ethyl propionate (EP), by volume of the total solvent.

The electrolyte lithium salts included: about 1.10M LiPF₆ and about 0.2M LiFSI.

The additives included: about 15% fluoroethylene carbonate (FEC), about 0.6% ethylene sulfate (DTD), about 0.6% vinylene carbonate (VC), about 3% succinonitrile (SN), about 2% hexanedinitrile (ADN), about 1% ethylene glycol bis(propionitrile) ether (DENE), about 3% 1,3-propyl sultone (PS), and about 5% fluorobenzene.

Copper collector had a coating material including carbon black, SBR binder, and CMC dispersant to form a mixed coating having a coating thickness of about 1 μm.

Anode material was lithium cobalt oxide (LCO) (LC9000H, purchased from Hunan Shanshan Advanced Material Co., Ltd., China).

The base substrate of the separator was made of PE, having a thickness of about 7 μm (PE 7 μm, purchased from SK Co., Ltd., Korea).

Performance tests were performed for the prepared lithium-ion polymer batteries. Test results indicated that the prepared lithium-ion polymer batteries provided performance stability and performance enhancement under a high voltage of 4.40V and 4.45V.

Further, the energy density in the 4.40V system is greater than about 750 Wh/L. while the energy density in the 4.45V system is greater than about 820 Wh/L.

Cycle life tests were performed under 4.45-3.00V at 25° C. for 500 times of 0.5 C/1 C cycles. The batteries illustrated a capacity retention rate of greater than about 80%.

Storage stability at high temperatures was tested for the prepared lithium-ion polymer batteries. The prepared batteries were stored at a temperature of 60° C. for 15 days. As a result, the thickness change rate is lower than about 6%, indicating the prepared lithium-ion polymer batteries have storage stability at high temperatures.

### EXAMPLE 11

To prepare a lithium-ion polymer battery, the cathode material included: artificial graphite mixed with about 10% SiO_{1.1} by weight, and further added with about 1%, by weight, a conductive agent including CNT.

The electrolyte solvent included: about 30% ethylene carbonate (EC), about 30% diethyl carbonate (DEC), and about 40% ethyl propionate (EP), by volume of the total solvent.

The electrolyte lithium salts included: about 1.10M LiPF₆ and 0.15M LiFSI.

The additives included: about 10% fluoroethylene carbonate (FEC), about 1.0% ethylene sulfate (DTD), about 0.5% vinylene carbonate (VC), about 2% succinonitrile (SN), about 3% hexanedinitrile (ADN), about 1.5% ethylene glycol bis(propionitrile) ether (DENE), about 4% 1,3-propyl sultone (PS), and about 4% fluorobenzene.

Copper collector had a coating material including carbon black, SBR binder, and CMC dispersant to form a mixed coating having a coating thickness of about 1 μm.

Anode material was lithium cobalt oxide (LCO) (LC9000H, purchased from Hunan Shanshan Advanced Material Co., Ltd., China).

The base substrate of the separator was made of PE, having a thickness of about 7 μm (PE 7 μm, purchased from SK Co., Ltd., Korea).

Performance tests were performed for the prepared lithium-ion polymer batteries. Test results indicated that the prepared lithium-ion polymer batteries provided performance stability and performance enhancement under a high voltage of 4.40V and 4.45V.

Further, the energy density in the 4.40V system is greater than about 750 Wh/L, while the energy density in the 4.45V system is greater than about 820 Wh/L.

Cycle life tests were performed under 4.45-3.00V at 25° C. for 500 times of 0.5 C/1 C cycles. The batteries illustrated a capacity retention rate of greater than about 80%.

Storage stability at high temperatures was tested for the prepared lithium-ion polymer batteries. The prepared batteries were stored at a temperature of 60° C. for 15 days. As a result, the thickness change rate is lower than about 6%, indicating the prepared lithium-ion polymer batteries have storage stability at high temperatures.

### EXAMPLE 12

To prepare a lithium-ion polymer battery, the cathode material included: artificial graphite mixed with about 10% SiO_{1.1} by weight, and further added with about 1%, by weight, a conductive agent including CNT.

The electrolyte solvent included: about 30% ethylene carbonate (EC), about 30% diethyl carbonate (DEC), and about 40% ethyl propionate (EP), by volume of the total solvent.

The electrolyte lithium salts included: about 1.00M LiPF₆ and about 0.20M LiFSI.

The additives included: about 12% fluoroethylene carbonate (FEC), about 0.5% ethylene sulfate (DTD), about 0.8% vinylene carbonate (VC), about 2.5% succinonitrile (SN), about 2.5% hexanedinitrile (ADN), about 1% ethylene glycol bis(propionitrile) ether (DENE), about 4% 1,3-propyl sultone (PS), and about 12% fluorobenzene.

Copper collector had a coating material including carbon black, SBR binder, and CMC dispersant to form a mixed coating having a coating thickness of about 1 μm.

Anode material was lithium cobalt oxide (LCO) (LC9000H, purchased from Hunan Shanshan Advanced Material Co., Ltd., China).

The base substrate of the separator was made of PE, having a thickness of about 7 μm (PE 7 μm, purchased from SK Co., Ltd., Korea).

Performance tests were performed for the prepared lithium-ion polymer batteries. Test results indicated that the prepared lithium-ion polymer batteries provided performance stability and performance enhancement under a high voltage of 4.40V and 4.45V.

Further, the energy density in the 4.40V system is greater than about 750 Wh/L, while the energy density in the 4.45V system is greater than, about 820 Wh/L.

Cycle life tests were performed under 4.40-3.00V at 25° C. for 500 times of 0.5 C/1 C cycles. The batteries illustrated a capacity retention rate of greater than about 80%.

Storage stability at high temperatures was tested for the prepared lithium-ion polymer batteries. The prepared batteries were stored at a temperature of 60° C. for 15 days. As a result, the thickness change rate is lower than about 6%, indicating the prepared lithium-ion polymer batteries have storage stability at high temperatures.

### COMPARATIVE EXAMPLE 2

To prepare a lithium-ion polymer battery, the cathode material included: artificial graphite mixed with about 10% nano silicon by weight. All other components, such as electrolyte solvent, electrolyte lithium salts, additives, collector, anode, separator, cathode, etc. for forming the lithium-ion polymer battery were the same as in Example 9.

Performance tests were performed for the prepared lithium-ion polymer batteries. Test results indicated that the prepared lithium-ion polymer batteries provided unstable cycle with a large thickness change rate under a high voltage of 4.40V and 4.45V.

Further, the energy density in the 4.40V system is greater than about 720 Wh/L, while the energy density in the 4.45V system is greater than about 780 Wh/L.

Cycle life tests were performed under 4.45-3.00V at 25° C. for 500 times of 0.5 C/1 C cycles. The batteries illustrated a capacity retention rate of less than about 50% and a thickness change rate of greater than about 30%.

Storage stability at high temperatures was tested for the prepared lithium-ion polymer batteries. The prepared batteries were stored at a temperature of 60° C. for 15 days. As a result, the thickness change rate is about 15%.

From the above Examples and Comparative Examples, the lithium-ion polymer batteries prepared: by mixing graphite and silicon oxide with a conductive agent material to form a cathode and using a mixed electrolyte, may have a high energy density and long cycle performance, as well as high temperature storage stability.

### EXAMPLE 13

To prepare a lithium-ion polymer battery, the cathode material included: artificial graphite having a compaction density of about 1.70 g/cm³.

The electrolyte solvent included: about 30% ethylene carbonate (EC), about 30% diethyl carbonate (DEC), about 20% propyl propionate (PP), and about 20% propylene carbonate (PC), by volume of the total solvent.

The additives included: about 0.5% ethylene sulfate (DTD), about 5% fluoroethylene carbonate (FEC), about 0.5% vinylene carbonate (VC), about 2% succinonitrile (SN), about 2% hexanedinitrile (ADN), about 0.5% ethylene glycol bis(propionitrile) ether (DENE), about 3% 1,3-propyl sultone (PS) and about 4% fluorobenzene.

The electrolyte lithium salts included: about 1.10M LiPF₆.

Copper collector had a coating material including carbon black, SBR binder, and CMC dispersant to form a mixed coating having a coating thickness of about 0.5 μm.

Anode material was lithium cobalt oxide (LCO) (LC9000E, purchased from Hunan Shanshan Advanced Material Co., Ltd., China).

The base substrate of the separator was made of PE, having a thickness of about 7 μm (PE 7 μm, purchased from SK Co., Ltd., Korea).

Performance tests were performed for the prepared lithium-ion polymer batteries. Three groups of the battery samples were tested in parallel. Table 5 illustrates performance test results at a high voltage of 4.40V, and Table 6 illustrates performance tests at a high voltage of 4.45V. The test methods and conditions were based on the national standard GB 31241-2014 (China).

TABLE 5

| | | Sample | |
|---|---|---|---|
| Test Type | Test Conditions | (pcs) | Result/Status |
| Electrical | Cycle life at 25° C. | 3 | Capacity retention rate |
| performance | | | after 500 cycles > 80% |
| | Cycle life at 45° C. | 3 | Capacity retention rate |
| | | | after 500 cycles > 80% |
| | Discharge rate: | 3 | 1 C capacity > 0.2 C |
| | 0.2 C/0.5 C/1.0 C/1.5 C | | capacity*97% |
| Storage | 85° C. for 6 hours | 3 | Thickness expansion < |
| performance | | | 10% |
| | 60° C. for 15 days | 3 | Thickness expansion < |
| | | | 10% |
| Safety | Overcharge performance | | Pass |
| performance | Room temperature | 3 | Pass |
| | external short-circuit | | |
| | performance | | |
| | High temperature | 3 | Pass |
| | external short-circuit | | |
| | performance | | |
| | Thermal shock | 3 | Pass |
| | performance at 130° C. | | |

As indicated in Table 5 and Table 6, the prepared lithium-ion polymer batteries under a high voltage of 4.40V and 4.45V provided performance stability and performance enhancement.

TABLE 6

| | | Sample | |
|---|---|---|---|
| Test Type | Test Conditions | (pcs) | Result/Status |
| Electrical | Cycle life at 25° C. | 3 | Capacity retention rate |
| performance | | | after 500 cycles > 80% |
| | Cycle life at 45° C. | 3 | Capacity retention rate |
| | | | after 500 cycles > 80% |
| | Discharge rate: | 3 | 1 C capacity > 0.2 C |
| | 0.2 C/0.5 C/1.0 C/1.5 C | | capacity*97% |
| Storage | 83° C. for 6 hours | 3 | Thickness expansion < |
| performance | | | 10% |
| | 60° C. for 15 days | 3 | Thickness expansion < |
| | | | 10% |
| Safety | Overcharge performance | 3 | Pass |
| performance | Room temperature | 3 | Pass |
| | external short-circuit | | |
| | performance | | |
| | High temperature | 3 | Pass |
| | external short-circuit | | |
| | performance | | |
| | Thermal shock | 3 | Pass |
| | performance at 130° C. | | |

Further, the energy density in the 4.40V system is greater than about 700 Wh/L, while the energy density in the 4.45V system is greater than about 750 Wh/L.

Cycle life tests were performed under 4.45-3.00V at 25° C. for 800 times of 0.7 C/1 C cycles. Three groups of sample were taken and tested in parallel. FIG. 14 illustrates a cycle performance according to Example 13. As indicated in FIG. 14, after being cycled for 800 times, the batteries had a capacity retention rate of greater than about 80%.

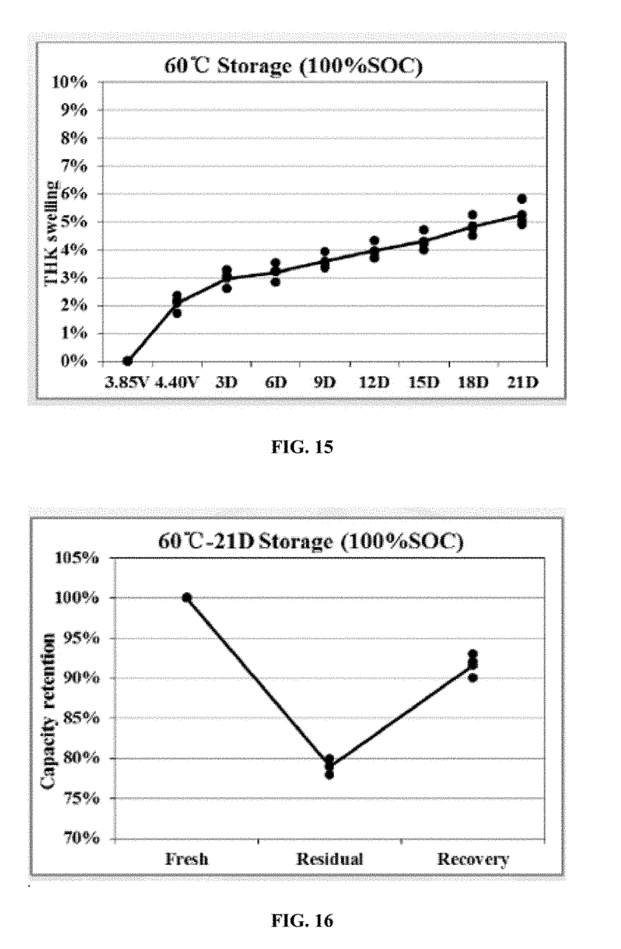

Storage stability at high temperatures was tested for the prepared lithium-ion polymer batteries. The prepared batteries were stored at a temperature of 60° C. for 21 days. FIG. 15 illustrates storage thickness change rate high at a temperature of batteries prepared in Example 13. As indicated in FIG. 15, after stored at a high temperature for about 21 days, the thickness change rate is lower than about 6%, indicating the prepared lithium-ion polymer batteries have storage stability at high temperatures. FIG. 16 illustrates residual capacity and recovery capacity. As indicated in FIG. 16, the prepared lithium-ion polymer batteries have a residual capacity of more than 80% and a recovery capacity of more than 90%.

### EXAMPLE 14

To prepare a lithium-ion polymer battery, the cathode material included: artificial graphite having a compaction density of about 1.85 g/cm³.

The electrolyte solvent included: about 30% ethylene carbonate (EC), about 20% diethyl carbonate (DEC), about 20% propyl propionate (PP), and about 30% propylene carbonate (PC), by volume of the total solvent.

The additives included: about 0.1% ethylene sulthte (DTD), about 6% fluoroethylene carbonate (FEC), about 0.1% vinylene carbonate (VC), about 3% succinonitrile (SN), about 3% hexanedinitrile (ADN), about 0.5% ethylene glycol bis(propionitrile) ether (DENE), about 4% 1,3-propyl sultone (PS), and about 5% fluorobenzene.

The electrolyte lithium salts included: about 1.30M LiPF₆.

Copper collector had a coating material including carbon black, SBR binder, and CMC dispersant to form a mixed coating having a coating thickness of about 0.5 μm.

Anode material was lithium cobalt oxide (LCO) (LC9000E, purchased from Hunan Shanshan Advanced Material Co., Ltd., China).

The base substrate of the separator was made of PE, having a thickness of about 7 μm (PE 7 μm, purchased from SK Co., Ltd., Korea).

Performance tests were performed for the prepared lithium-ion polymer batteries. Test results indicated that the prepared lithium-ion polymer batteries provided performance stability and performance enhancement under a high voltage of 4.40V and 4.45V.

Further, the energy density in the 4.40V system is greater than about 700 Wh/L, while the energy density in the 4.45V system is greater than about 750 Wh/L.

Cycle life tests were performed under 4.45-3.00V at 25° C. for 800 times of 0.7 C/1 C cycles. After being cycled for about 800 times, the batteries illustrated a capacity retention rate of greater than about 80%.

Storage stability at high temperatures was tested for the prepared lithium-ion polymer batteries. The prepared batteries were stored at a temperature of 60° C. for 21 days. As a result, the thickness change rate is lower than about 6%, indicating the prepared lithium-ion polymer batteries have storage stability at high temperatures.

### EXAMPLE 15

To prepare a lithium-ion polymer battery, the cathode material included: artificial graphite having a compaction density of about 1.85 g/cm³.

The electrolyte solvent included: about 20% ethylene carbonate (EC), about 30% diethyl carbonate (DEC), about 30% propyl propionate (PP), and about 20% propylene carbonate (PC), by volume of the total solvent.

The additives include: about 1% ethylene sulfate (DTD), about 5% fluoroethylene carbonate (FTC), about 1% vinylene carbonate (VC), about 2% hexanedinitrile (ADN), about 2% ethylene glycol bis(propionitrile) ether (DENE), about 3% 1,3-propyl sultone (PS), and about 3% fluorobenzene.

The electrolyte lithium salts included: about 1.30M LiPF₆.

Copper collector had a coating material including carbon black, SBR binder, and CMC dispersant to form a mixed coating having a coating thickness of about 0.5 μm.

Anode material was lithium cobalt oxide (LCO) (LC9000E, purchased from Hunan Shanshan Advanced Material Co., Ltd., China).

The base substrate of the separator was made of PE, having a thickness of about 7 μm (PE 7 μm, purchased from SK Co., Ltd., Korea).

Performance tests were performed for the prepared lithium-ion polymer batteries. Test results indicated that the prepared lithium-ion polymer batteries provided performance stability and performance enhancement under a high voltage of 4.40V and 4.45V.

Further, the energy density in the 4.40V system is greater than about 700 Wh/L, while the energy density in the 4.45V system is greater than about 750 Wh/L.

Cycle life tests were performed under 4.45-3.00V at 25° C. for 800 times of 0.7 C/1 C cycles. After being cycled for about 800 times, the batteries illustrated a capacity retention rate of greater than about 80%.

Storage stability at high temperatures was tested for the prepared lithium-ion polymer batteries. The prepared batteries were stored at a temperature of 60° C. for 21 days. As a result, the thickness change rate is lower than about 6%, indicating the prepared lithium-ion polymer batteries have storage stability at high temperatures.

### EXAMPLE 16

To prepare a lithium-ion polymer battery, the cathode material included: artificial graphite having a compaction density of about 1.85 g/cm³.

The electrolyte solvent included: about 20% ethylene carbonate (EC), about 20% diethyl carbonate (DEC), about 30% propyl propionate (PP), and about 30% propylene carbonate (PC), by volume of the total solvent.

The additives included: about 0.1% ethylene sulfate (DTD), about 8% fluoroethylene carbonate (FEC), about 4% hexanedinitrile (ADN), about 2% ethylene glycol bis(propionitrile) ether (DENE), about 1% 1,3-propyl sultone (PS) and about 10% fluorobenzene.

The electrolyte lithium salts included: about 1.30M LiPF₆.

Copper collector had a coating material including carbon black, SBR binder, and CMC dispersant to form a mixed coating having a coating thickness of about 0.5 μm.

Anode material was lithium cobalt oxide (LCO) (LC9000E, purchased from Hunan Shanshan Advanced Material Co., Ltd., China).

The base substrate of the separator was made of PE, having a thickness of about 7 μm (PE 7 μm, purchased from SK Co., Ltd., Korea).

Performance tests were performed for the prepared lithium-ion polymer batteries. Test results indicated that the prepared lithium-ion polymer batteries provided performance stability and performance enhancement under a high voltage of 4.40V and 4.45V.

Further, the energy density in the 4.40V system is greater than about 700 Wh/L, while the energy density in the 4.45V system is greater than about 750 Wh/L.

Cycle life tests were performed under 4.45-3.00V at 25° C. for 800 times of 0.7 C/1 C cycles. After being cycled for about 800 times, the batteries illustrated a capacity retention rate of greater than about 80%.

Storage stability at high temperatures was tested for the prepared lithium-ion polymer batteries. The prepared batteries were stored at a temperature of 60° C. for 21 days. As a result, the thickness change rate is lower than about 6%, indicating the prepared lithium-ion polymer batteries have storage stability at high temperatures.

### EXAMPLE 17

To prepare a lithium-ion polymer battery, the cathode material included: artificial graphite having a compaction density of about 1.85 g/cm³.

The electrolyte solvent included: about 30% ethylene carbonate (EC), about 30% diethyl carbonate (DEC), about 20% propyl propionate (PP), and about 20% propylene carbonate (PC), by volume of the total solvent.

The additives included: about 1.5% ethylene sulfate (DTD), about 2% fluoroethylene carbonate (FEC), about 4% succinonitrile (SN), about 4% hexanedinitrile (ADN), about 4% ethylene glycol bis(propionitrile) ether (DENE), about 5% 1,3-propyl sultone (PS), and about 10% fluorobenzene.

The electrolyte lithium salts included: about 1.30M LiPF₆.

Copper collector had a coating material including carbon black, SBR binder, and CMC dispersant to form a mixed coating having a coating thickness of about 0.5 μm.

Anode material was lithium cobalt oxide (LCO) (LC9000E, purchased from Hunan Shanshan Advanced Material Co., Ltd., China).

The base substrate of the separator was made of PE, having a thickness of about 7 μm (PE 7 μm, purchased from SK Co., Ltd., Korea).

Performance tests were performed for the prepared lithium-ion polymer batteries. Test results indicated that the prepared lithium-ion polymer batteries provided performance stability and performance enhancement under a high voltage of 4.40V and 4.45V.

Further, the energy density in the 4.40V system is greater than about 700 Wh/L, while the energy density in the 4.45V system is greater than about 750 Wh/L.

Cycle life tests were performed under 4.45-3.00V at 25° C. for 800 times of 0.7 C/1 C cycles. After being cycled for about 800 times, the batteries illustrated a capacity retention rate of greater than about 80%.

Storage stability at high temperatures was tested for the prepared lithium-ion polymer batteries. The prepared batteries were stored at a temperature of 60° C. for 21 days. As a result, the thickness change rate is lower than about 6%, indicating the prepared lithium-ion polymer batteries have storage stability at high temperatures.

### EXAMPLE 18

To prepare a lithium-ion polymer battery, the cathode material included: artificial graphite having a compaction density of about 1.85 g/cm³.

The electrolyte solvent included: about 50% diethyl carbonate (DEC), about 30% propyl propionate (PP), and about 20% propylene carbonate (PC), by volume of the total solvent.

The additives included: about 0.5% ethylene sulfate (DTD), about 6% fluoroethylene carbonate (FEC), about 0.5% vinylene carbonate (VC), about 2% succinonitrile (SN), about 2% hexanedinitrile (ADN), about 1% ethylene glycol bis(propionitrile) ether (DENE), about 3% 1,3-propyl sultone (PS), and about 5% fluorobenzene.

The electrolyte lithium salts included: about 1.30M LiPF₆.

Copper collector had a coating material including carbon black, SBR binder, and CMC dispersant to form a mixed coating having a coating thickness of about 0.5 μm.

Anode material was lithium cobalt oxide (LCO) (LC9000E, purchased from Hunan Shanshan Advanced Material Co., Ltd., China).

The base substrate of the separator was made of PE, having a thickness of about 7 μm (PE 7 μm, purchased from SK Co., Ltd., Korea).

Performance tests were performed for the prepared lithium-ion polymer batteries. Test results indicated that the prepared lithium-ion polymer batteries provided performance stability and performance enhancement under a high voltage of 4.40V and 4.45V.

Further, the energy density in the 4.40V system is greater than about 700 Wh/L, while the energy density in the 4.45V system is greater than about 750 Wh/L.

Cycle life tests were performed under 4.45-3.00V at 25° C. for 800 times of 0.7 C/1 C cycles. After being cycled for about 800 times, the batteries illustrated a capacity retention rate of greater than about 80%.

Storage stability at high temperatures was tested for the prepared lithium-ion polymer batteries. The prepared batteries were stored at a temperature of 60° C. for 21 days. As a result, the thickness change rate is lower than about 6%, indicating the prepared lithium-ion polymer batteries have storage stability at high temperatures.

### EXAMPLE 19

To prepare a lithium-ion polymer battery, the cathode material included: artificial graphite having a compaction density of about 1.85 g/cm³.

The electrolyte solvent included: about 30% ethylene carbonate (EC), about 50% propyl propionate (PP), and about 20% propylene carbonate (PC), by volume of the total solvent.

The additives included: about 1.0% ethylene sulfate (DTD), about 2% fluoroethylene carbonate (FEC), about 0.1% vinylene carbonate (VC), about 4% succinonitrile (SN), about 4% hexanedinitrile (ADN), about 1% ethylene glycol bis(propionitrile) ether (DENE), about 2% 1,3-propyl sultone (PS) and about 2% fluorobenzene.

The electrolyte lithium salts included: about 1.30M LiPF₆.

Copper collector had a coating material including carbon black, SBR binder, and CMC dispersant to form a mixed coating having a coating thickness of about 0.5 μm.

Anode material was lithium cobalt oxide (LCO) (LC9000E, purchased from Hunan Shanshan Advanced Material Co., Ltd., China).

The base substrate of the separator was made of PE, having a thickness of about 7 μm (PE 7 μm, purchased from SK Co., Ltd., Korea).

Performance tests were performed for the prepared lithium-ion polymer batteries. Test results indicated that the prepared lithium-ion polymer batteries provided performance stability and performance enhancement under a high voltage of 4.40V and 4.45V.

Further, the energy density in the 4.40V system is greater than about 700 Wh/L, while the energy density in the 4.45V system is greater than about 750 Wh/L.

Cycle life tests were performed under 4.45-3.00V at 25° C. for 800 times of 0.7 C/1 C cycles. After being cycled for about 800 times, the batteries illustrated a capacity retention rate of greater than about 80%.

Storage stability at high temperatures was tested for the prepared lithium-ion polymer batteries. The prepared batteries were stored at a temperature of 60° C. for 21 days. As a result, the thickness change rate is lower than about 6%, indicating the prepared lithium-ion polymer batteries have storage stability at high temperatures.

### EXAMPLE 20

To prepare a lithium-ion polymer battery, the cathode material included: artificial graphite having a compaction density of about 1.85 g/cm³.

The electrolyte solvent included: about 20% ethylene carbonate (EC), about 50% diethyl carbonate (DEC), and about 30% propyl propionate (PP), by volume of the total solvent.

The additives included: about 0.1% ethylene sulfate (DTD), about 10% fluoroethylene carbonate (FEC), about 1% vinylene carbonate (VC), about 1% succinonitrile (SN), about 1% hexanedinitrile (ADN), about 4% ethylene glycol bis(propionitrile) ether (DENE), about 5% 1,3-propyl sultone (PS) and about 10% fluorobenzene.

The electrolyte lithium salts included: about 1.30M LiPF₆.

Copper collector had a coating material including carbon black, SBR binder, and CMC dispersant to form a mixed coating having a coating thickness of about 0.5 μm.

Anode material was lithium cobalt oxide (LCO) (LC9000E, purchased from Hunan Shanshan Advanced Material Co., Ltd., China).

The base substrate of the separator was made of PE, having a thickness of about 7 μm (PE 7 μm, purchased from SK Co., Ltd., Korea).

Performance tests were performed for the prepared lithium-ion polymer batteries. Test results indicated that the prepared lithium-ion polymer batteries provided performance stability and performance enhancement under a high voltage of 4.40V and 4.45V.

Further, the energy density in the 4.40V system is greater than about 700 Wh/L, while the energy density in the 4.45V system is greater than about 750 Wh/L.

Cycle life tests were performed under 4.45-3.00V at 25° C. for 800 times of 0.7 C/1 C cycles. Alter being cycled for about 800 times, the batteries illustrated a capacity retention rate of greater than about 80%.

Storage stability at high temperatures was tested for the prepared lithium-ion polymer batteries. The prepared batteries were stored at a temperature of 60° C. for 21 days. As a result, the thickness change rate is lower than about 6%, indicating the prepared lithium-ion polymer batteries have storage stability at high temperatures.

### EXAMPLE 21

To prepare a lithium-ion polymer battery, the cathode material included: artificial graphite having a compaction density of about 1.85 g/cm³.

The electrolyte solvent included: about 50% ethylene carbonate (EC), about 30% diethyl carbonate (DEC), and about 20% propyl propionate (PP), by volume of the total solvent.

The additives included: about 0.5% ethylene sulfate (DTD), about 5% fluoroethylene carbonate (FEC), about 0.5% vinyl ethylene carbonate (VEC), about 1% polycyano-type additives (e.g., from SCT Additives, LLC), about 2% hexanedinitrile (ADN), about 1% ethylene glycol bis(propionitrile) ether (DENE), about 3% 1,3-propyl sultone (PS), and about 4% fluorobenzene.

The electrolyte lithium salts included: about 1.30M LiPF₆.

Copper collector had a coating material including carbon black, SBR binder, and CMC dispersant to form a mixed coating having a coating thickness of about 0.5 μm.

Anode material was lithium cobalt oxide (LCO) (LC9000E, purchased from Hunan Shanshan Advanced Material Co., Ltd., China).

The base substrate of the separator was made of PE, having a thickness of about 7 μm (PE 7 μm, purchased from SK Co., Ltd., Korea).

Performance tests were performed for the prepared lithium-ion polymer batteries. Test results indicated that the prepared lithium-ion polymer batteries provided performance stability and performance enhancement under a high voltage of 4.40V and 4.45V.

Further, the energy density in the 4.40V system is greater than about 700 Wh/L, while the energy density in the 4.45V system is greater than about 750 Wh/L.

Cycle life tests were performed under 4.45-3.00V at 25° C. for 800 times of 0.7 C/1 C cycles. After being cycled for about 800 times, the batteries illustrated a capacity retention rate of greater than about 75%.

Storage stability at high temperatures was tested for the prepared lithium-ion polymer batteries. The prepared batteries were stored at a temperature of 60° C. for 21 days. As a result, the thickness change rate is about 10%, indicating the prepared lithium-ion polymer batteries have storage stability at high temperatures.

In this manner, the prepared lithium-ion polymer battery had high energy density and long cycle performance, and high temperature storage stability.

In the present disclosure, relational terms such as first and second, and the like, may be used solely to distinguish one entity or action front another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the present specification are described in a progressive manner, in which each embodiment focusing on aspects different from other embodiments, and the same and similar parts of each embodiment may be referred to each other. Since the disclosed electronic device corresponds to the disclosed information processing method, the description of the disclosed electronic device is relatively simple, and the correlation may be referred to the method section.

The description of the disclosed embodiments is provided to illustrate the present disclosure to those skilled in the art. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A lithium-ion polymer battery comprising:
a battery electrolyte, including:
a solvent, including propyl propionate and at least two selected from the group consisting of ethylene carbonate, diethyl carbonate, and propylene carbonate; and
an additive, including one or more of ethylene sulfate, fluoroethylene carbonate, hexanedinitrile, ethylene glycol bis(propionitrile) ether, 1,3-propyl sultone, and fluorobenzene.

2. The battery according to claim 1, wherein the solvent includes the ethylene carbonate, the diethyl carbonate, the propyl propionate, and the propylene carbonate.

3. The battery according to claim 2, wherein:
by volume of a total solvent of 100%,
the ethylene carbonate is in a range from about 10% to about 50%;
the diethyl carbonate is in a range from about 10% to about 50%;
the propyl propionate is in a range from about 10% to about 50%; and
the propylene carbonate is in a range from about 10% to about 50%.

4. The battery according to claim 3, wherein the solvent includes:
the ethylene carbonate in a range from about 10% to about 30%;
the diethyl carbonate in a range from about 10% to about 30%;
the propyl propionate in a range from about 10% to about 30%; and
the propylene carbonate in a range from about 10% to about 30%.

5. The battery according to claim 1, wherein the additive further includes one or more of vinylene carbonate and succinonitrile.

6. The battery according to claim 5, wherein the additive includes the ethylene sulfate, the fluoroethylene carbonate, the hexanedinitrile, the ethylene glycol bis(propionitrile) ether, the 1,3-propyl sultone, the fluorobenzene, the vinylene carbonate, and the succinonitrile.

7. The battery according to claim 1, wherein:
by weight of a total additive of 100%, the additive includes:
the ethylene sulfate in a range from about 0.1% to about 1.5%;
the fluoroethylene carbonate in a range from about 2% to about 10%;
the vinylene carbonate in a range from about 0.1% to about 1%;
the succinonitrile in a range from about 1% to about 4%;
the hexanedinitrile in a range from about 1% to about 4%;
the ethylene glycol bis(propionitrile) ether (DENE) in a range from about 0.5% to about 4%;
the 1,3-propyl sultone in a range from about 1% to about 5%; and
the fluorobenzene in a range from about 2% to about 10%.

8. The battery according to claim 7, wherein the additive includes:
the ethylene sulfate in a range from about 0.5% to about 1.0%;
the fluoroethylene carbonate in a range from about 4% to about 8%;
the vinylene carbonate in a range from about 0.3% to about 0.7%;
the succinonitrile in a range from about 2% to about 4%;
the hexanedinitrile in a range from about 2% to about 4%;
the ethylene glycol bis(propionitrile) ether in a range from about 2% to about 3%;
the 1,3-propyl sultone in a range from about 2% to about 3%; and
the fluorobenzene in a range from about 4% to about 8%.

9. An electronic device, comprising the battery according to claim 1.

10. A lithium-ion polymer battery, comprising:
a battery separator including:
a base substrate; and
an aqueous functional layer, compounded on a surface of the base substrate,
wherein the aqueous functional layer contains micropores and is a binder.

11. The battery according to claim 10, wherein the aqueous functional layer is made of one or more of an inorganic nano-ceramic material and an aqueous functional binder material.

12. The battery according to claim 11, wherein the inorganic nano-ceramic material includes one or more of alumina and magnesium hydroxide.

13. The battery according to claim 11, wherein the aqueous functional binder material includes one or more of polyvinylidene fluoride (PVDF) and polymethylmethacrylate (PMMA).

14. The battery according to claim 10, wherein:
the base substrate has a first surface and a second surface opposite to the first surface, and
the aqueous functional layer includes an inorganic nano-ceramic layer, compounded on the first surface of the base substrate, and an aqueous functional binder layer, compounded on the second surface of the base substrate.

15. The battery according to claim 10, wherein the aqueous functional layer includes: an inorganic nano-ceramic layer and an aqueous functional binder layer, stacked layer-by-layer, on at least one surface of the base substrate.

16. The battery according to claim 10, wherein the aqueous functional layer is made of a mixed material containing an inorganic nano-ceramic material and an aqueous functional binder material, compounded on at least one surface of the base substrate.

17. A lithium-ion polymer battery, comprising:
a cathode, made of a cathode material including:
graphite,
a silicon-oxide-containing material, and
a conductive agent.

18. The battery according to claim 17, wherein the silicon-oxide-containing material is in a range from about 10% to about 50% by weight of a total cathode material.

19. The battery according to claim 17, wherein the conductive agent is in a range of about 1% to about 5% by weight of a total cathode material.

20. The battery according to claim 17, wherein the silicon-oxide-containing material is a three-dimensional network composite material having: elementary substance Si and SiOx uniformly dispersed, wherein x is from 0.5 to 1.5.
